(19) United States
(12) Patent Application Publication
(10) Pub. No.: US 2008/0100155 A1
(43) Pub. Date: May 1, 2008

(54) Spindle motor having radial and axial bearing systems

(76) Inventors: Martin Engesser, Donaueschingen (DE); Stefan Schwamberger, Lohsa (DE); Andrey Pulnikov, Villingen-Schwenningen (DE); Vladimir V. Popov, Villingen-Schwenningen (DE)

Correspondence Address: COOPER & DUNHAM, LLP, 1185 AVENUE OF THE AMERICAS, NEW YORK, NY, 10036, US

(21) Appl. No.: 11/975,432

(22) Filed: Oct. 19, 2007

(30) Foreign Application Priority Data
Oct. 26, 2006 (DE) 10 2006 051 018.6

(51) Int. Cl. H02K 7/09; H02K 1/27

(52) U.S. Cl. 310/46; 310/90.5

(57) ABSTRACT

The invention relates to a spindle motor having a stationary part and a rotating part that are rotatably supported with respect to each other by means of radial and axial bearing systems, the radial bearing system being a fluid bearing and the rotating part being driven by an electromagnetic drive system. The spindle motor is characterized in that the axial bearing system is designed as a magnetic bearing and that it operates against a magnetic preload.

### BACKGROUND OF THE INVENTION

The invention relates to a spindle motor having radial and axial bearing systems according to the preamble of patent claim 1.

### PRIOR ART

An important requirement for these kinds of rapidly rotating spindle motors, used, for example, for driving the storage disks of a hard disk drive, is to produce a bearing that has the least possible backlash and the lowest possible friction.

A common feature of all motor designs is that a rotary driven rotor (hub) is disposed on a stationary base and that the hub is supported on the base by means of appropriate axial and radial bearings. A well-known drive principle for these motors is to dispose a stator arrangement on the base that interacts via an air gap with a magnet disposed on the inside surface of the driven rotor. The rotor is set in rotation using an electromagnetic rotating field generated accordingly in the stator arrangement.

The applied radial and axial bearings should be subject to the least possible friction. Nowadays, hydrodynamic sliding bearings that operate at very low loss are preferably used for this purpose. However, the axial bearing components alone account for about 30% of overall bearing losses. In addition, due to tight manufacturing tolerances, their manufacture is relatively complex and expensive. The bearing surfaces of the fluid dynamic axial bearings rest against each other when the motor is stationary, which means that solid friction occurs between these bearing surfaces on starting and stopping the motor. This results in increased wear and tear to the axial bearing and increased energy consumption of the motor. Examples of these kinds of hydrodynamic bearings for spindle motors are revealed in DE 10 2004 040 295 A1.

### SUMMARY OF THE INVENTION

The invention has the object of providing a spindle motor having a bearing arrangement that has less bearing friction and thus lower power consumption compared to a pure fluid bearing system.

In achieving the object, the invention is characterized by the technical teaching outlined in claim 1.

An important characteristic of the invention is that here a magnetic axial bearing is associated with a radial fluid bearing, the magnetic bearing operating against a magnetic preload on one side.

An important advantage of a magnetic bearing compared to other known types of bearings is that the magnetic bearing operates almost friction-free, in both static operation, i.e. when the motor is stationary, as well as in dynamic operation. Since the magnetic bearing operates independently of the rotational speed of the motor, any solid friction between the stationary part and the moving part of the motor is precluded.

In a preferred embodiment of the invention, the stationary part of the motor substantially comprises a base, a bearing bush connected to the base as well as a stator arrangement disposed on the base. The rotating part substantially comprises a shaft rotatably supported in the bearing bush, a hub connected to the shaft and a magnet arrangement that is disposed on the hub.

According to the invention, the stator arrangement and the magnet arrangement are substantially disposed on one plane perpendicular to the rotational axis of the spindle motor, the magnet arrangement being enclosed by the stator arrangement in the case of an inner rotor motor. The opposite being true for an outer rotor motor where the stator arrangement is enclosed by the magnet arrangement.

In a preferred embodiment of the invention, the magnetic bearing consists of a first magnet disposed on the rotating part that is located opposite a second magnet disposed on the stationary part. Here, the first magnet is preferably disposed on a substantially radially extending surface of the hub, this surface being located opposite the radially extending surface of the bearing bush carrying the second magnet.

According to one possible embodiment, both magnets may be annular in shape, only one of the magnets, however, being preferably formed as a complete magnetic ring. The other magnet preferably consists of a plurality of annularly disposed magnet segments. Provision can be made, however, for both magnets to be made up of a plurality of annularly disposed magnet segments.

In a further embodiment, at least one of the two magnets can be formed from a plurality of concentric, magnetized rings of differing diameters that are set coaxially within each other. The rings may all be magnetized in the same direction or alternately in the opposite direction. Furthermore, the individual rings may be made of different materials and/or magnetized at different strengths. In a further modification, it is preferable if a permanent magnet is not used for a central ring.

In order to ensure that the magnetic bearing has good load bearing capability, and particularly a uniform load bearing capability if the magnets are laterally offset, provision is made in a preferred embodiment for one magnet, preferably the magnet associated with the hub, to have a greater width in a radial direction than the second magnet associated with the bearing bush.

The magnetic preload is best achieved by an axial offset (d) of the stator arrangement vis-à-vis the magnet arrangement.

The rotor magnet and the axial bearing magnets are preferably plastic-bonded magnets which, however, are not particularly strong. Due to the similar behavior shown by the applied magnetic materials, such as thermal behavior, it is relatively simple to balance out the magnetic bearing.

The magnets of the magnetic bearing are preferably polarized such that they repulse one another. On the other hand, the magnetic preload is chosen so as to produce a force that is the opposite of the repulsive force of the magnetic bearing. The magnetic bearing is thus held in equilibrium.

The situation could of course be the opposite with the magnets of the magnetic bearing being polarized such that they attract each other and the magnetic preload exerting a corresponding repulsive force directed in the opposite direction.

The main results of using the magnetic bearing include lower power dissipation of the motor in operation, a longer useful life, and, in particular, a lower starting torque requirement.

What is more, it is considerably easier to manufacture the magnetic axial bearing than it is to manufacture an axial fluid bearing, for example, since considerably wider axial bearing gaps are permissible.

### BRIEF DESCRIPTION OF THE DRAWINGS

An embodiment of the invention is described in more detail below on the basis of the drawings. Further characteristics and advantages of the invention can be derived from the drawings and their description.

FIG. 1 shows a schematic section through a spindle motor according to the invention having a magnetic bearing.

FIG. 2 shows a schematic section through a second embodiment of a spindle motor according to the invention having a magnetic bearing.

FIG. 3 shows a schematic section through a third embodiment of a spindle motor according to the invention having a magnetic bearing.

FIG. 4 shows an exemplary diagram of the forces acting in the axial bearing.

### DESCRIPTION OF PREFERRED EMBODIMENTS OF THE INVENTION

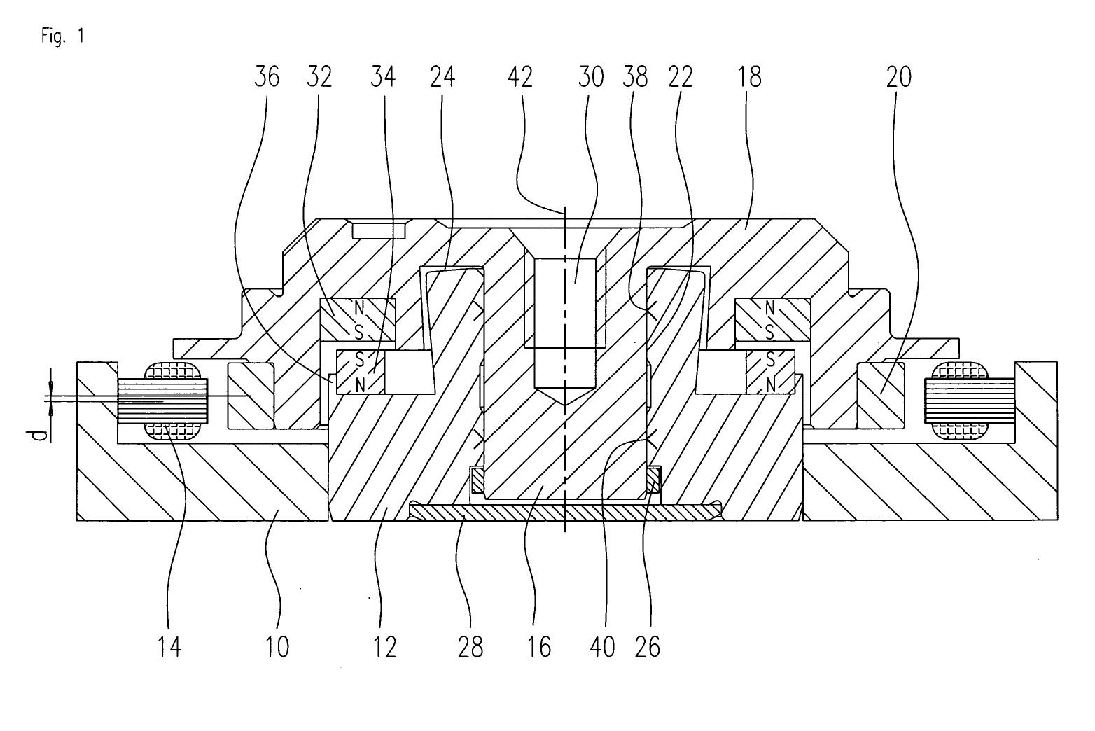

FIG. 1 shows a spindle motor according to the invention having a base 10 that can, for example, take the form of a baseplate or base flange. A bearing bush 12 is accommodated in a recess in the base 10, the bearing bush being pressed into the base or connected to the base by means of welding or bonding. A stator arrangement 14 is provided in a conventional way at the outer region of the base 10, the stator arrangement enclosing the bearing bush 12 approximately annularly.

The bearing bush 12 has a central bore in which a shaft 16 is accommodated, the surfaces of the bore of the bearing bush 12 and the outer surface of the shaft 16 being spaced apart from each other by a bearing gap 22. The bearing gap 22 is filled with a bearing fluid, preferably a bearing oil. The shaft 16 is preferably supported vis-à-vis the bearing bush 12 by means of two radial bearings 38 and 40 lying one above the other, the radial bearings taking the form of fluid bearings that are marked by appropriate bearing patterns disposed either on the outside circumference of the shaft 16 or on the inside circumference of the bearing bush 12. The construction and function of a fluid dynamic bearing are well-known so that no further details are provided here.

The end of the shaft 16 protruding beyond the bearing bush 12 is connected to a hub 18, the shaft 16 and the hub 18 either being formed integrally as a single piece, as shown in FIG. 1, or made up of two separate parts connected to each other. The hub 18 is approximately bell-shaped in design and extends beyond and partially encloses the bearing bush 12.

An annular permanent magnet 20 is disposed at an outside circumference of the hub 18, the annular permanent magnet 20 being located opposite the stator arrangement 14 and, together with the stator arrangement 14, forming the electromagnetic drive system of the spindle motor.

An end face of the bearing bush 12 facing the hub 18 as well as a surface at the outside circumference of the bearing bush and the opposing surface of the hub 18 are all preferably slanted, so that a tapered capillary gap 24 is produced between the hub 18 and the bearing bush 12, narrowing in the direction of the bearing gap 22, the capillary gap 24 being used as a conical capillary seal and being at least partially filled with bearing fluid. This conical capillary seal is used on the one hand to seal the bearing gap 22 towards the outside and on the other hand it acts as a fluid reservoir.

The lower open end of the bearing bush is covered by a cover plate 28 that tightly seals the bearing in this region. To prevent the shaft 16 from falling out of the bearing bush 12, a stopper ring 26 is preferably provided at the lower, free end of the shaft. The stopper ring 26 is freely disposed in an annular groove in the bearing bush 12 and does not come into contact with the surfaces of the bearing bush 12 or of the cover plate 28 when the spindle motor is operating under normal conditions.

The hub 18 or the shaft 16 respectively has a central tapped bore 30 which is used to secure a mounting clamp (not illustrated). If the spindle motor is used to drive hard disk drives, storage disks (not illustrated), for example, can be fixed to the hub 18 using this mounting clamp.

According to the invention, the rotating parts of the motor, i.e. the shaft 16 or the hub 18 respectively, are axially supported vis-à-vis the bearing bush 12 or the base 10 respectively by means of a magnetic bearing that is provided between the stationary part of the motor and the rotating part of the motor. The magnetic bearing comprises a first magnet 32 that is disposed in an annular recess in the hub 18 provided for this purpose. This annular recess lies opposite the radially extending surface of a step that is formed in the bearing bush 12. This distinct step carries a second magnet 34 that lies opposite the first magnet 32 in an axial direction. The second magnet 34 is held, for example, by an annular stop 36 on the bearing bush 12, whereas the first magnet is disposed in the recess in the hub 18 as described above.

The magnets 32 and 34 are polarized such that identical poles are located opposite each other so that the magnets repulse one another. An air gap corresponding to the repulsive force is thereby formed between the magnets 32, 34, so that the hub 18 is lifted up off the bearing bush 12 and the two parts do not touch each other, at least not with their radially extending surfaces. The two magnets 32 and 34 are preferably annular in shape, or they are at least made up of a plurality of annularly disposed magnet segments, the diameter of the magnets 32, 34 being made as large as possible since the stability of the bearing increases in line with the diameter of the magnets.

In order to stabilize the bearing, the magnetic bearing preferably operates against a magnetic preload whose force acts in the opposite direction to that of the magnetic bearing. The preload acting as a counter bearing to the magnetic bearing is generated by the stator arrangement 14 together with the magnet arrangement 20 of the rotor in that the rotor magnet 20 is offset by a distance d to the magnetic center of the stator arrangement. In the present case, the magnet 20 is disposed above the magnetic center of the stator arrangement 14 by the distance d, so that the magnet 20 is attracted by the stator arrangement 14 in the direction of the base 10. This force of attraction acts in the opposite direction to the repulsive force of the two magnets 32, 34 of the magnetic bearing. This goes to create a stable suspension of the hub 18 in an axial direction.

One of the magnets 32, 34 (magnet 32 in the example) is designed to be wider in a radial direction than the other opposing magnet. Enlarging the width of the magnet 32 in this way goes to ensure that any radial offset of the two magnets, caused, for example, by assembly tolerances, will only produce minimal changes to the magnetic forces.

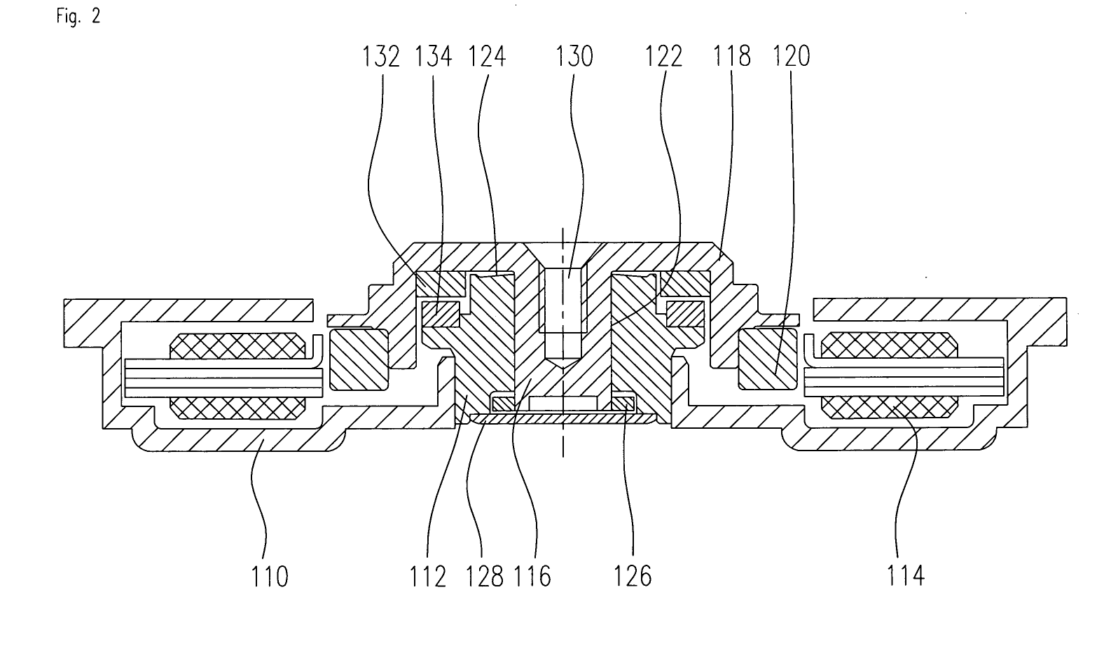

FIG. 2 shows a second embodiment of a spindle motor according to the invention having a base 110 in which a bearing bush 112 is accommodated. A stator arrangement 114 is provided in a conventional way at the outer region of the base 110, the stator arrangement enclosing the bearing bush 112 approximately annularly.

The bearing bush 112 has a central bore in which a shaft 116 is accommodated, the surface of the bore in the bearing bush 112 and the outer surface of the shaft 116 being spaced apart from one another by a bearing gap 122. The bearing gap 122 is filled with a bearing fluid, preferably a bearing oil. The shaft 116 is supported vis-à-vis the bearing bush 112 by means of fluid dynamic radial bearings. The end of the shaft 116 protruding beyond the bearing bush 112 is connected to a hub 118, the shaft 116 and the hub 118 being integrally formed, for example, as a single piece as shown in FIG. 2. The hub 118 is approximately bell-shaped in design and extends beyond and partially encloses the bearing bush 112. The hub 118 or the shaft 116 respectively may have a central tapped bore 130.

An annular permanent magnet 120 is disposed at an outside circumference of the hub 118, the annular permanent magnet 120 being located opposite the stator arrangement 114 and, together with the stator arrangement 114, forming the electromagnetic drive system of the spindle motor.

An end face of the bearing bush 112 facing the hub 118 as well as an opposing surface of the hub 118 are preferably slanted, so that a tapered capillary gap 124 is produced between the hub 118 and the bearing bush 112 narrowing in the direction of the bearing gap 122, the capillary gap 124 being used as a capillary seal. The capillary gap 124 is connected to the bearing gap and is at least partially filled with bearing fluid. The capillary gap 124 is used on the one hand to seal the bearing gap 122 towards the outside and on the other hand it acts as a fluid reservoir. The lower open end of the bearing bush is covered by a cover plate 128 that tightly seals the bearing in this region.

To prevent the shaft 116 from falling out of the bearing bush 112, a stopper ring 126 is preferably provided at the lower, free end of the shaft. The stopper ring 126 is freely disposed in an annular groove in the bearing bush 112 and does not come into contact with the surfaces of the bearing bush 112 or of the cover plate 128 when the spindle motor is operating under normal conditions.

Here again, the rotating parts of the motor, i.e. the shaft 116 or the hub 118 respectively, are axially supported vis-à-vis the bearing bush 112 or the base 110 respectively by means of a magnetic bearing that is provided between the stationary part of the motor and the rotating part of the motor. The magnetic bearing comprises a first magnet 132 that is disposed on the inside surface of the hub 118 facing the bearing bush 112. The magnet 132 lies axially opposite a second magnet 134 that is disposed in a step in the bearing bush 112.

The magnets 132 and 134 are polarized such that identical poles are located opposite each other so that the magnets 132, 134 repulse one another. An air gap corresponding to the repulsive force is thereby formed between the magnets 132, 134, so that the hub 118 is lifted up off the bearing bush 112 and the two parts do not touch each other, at least not with their radially extending surfaces. The two magnets 132 and 134 are preferably annular in shape, or they are at least made up of a plurality of annularly disposed magnet segments, the diameter of the magnets 132, 134 being made as large as possible since the stability of the bearing increases in line with the diameter of the magnets.

In order to stabilize the bearing, the magnetic bearing preferably operates against a magnetic preload as described in conjunction with FIG. 1.

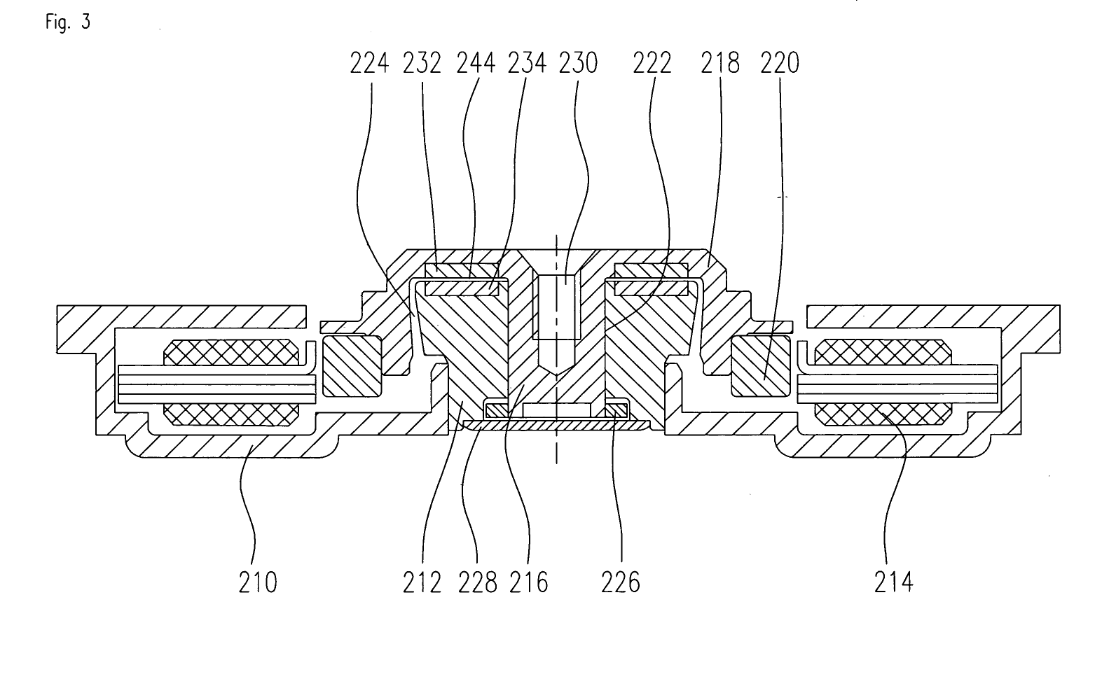

FIG. 3 shows a third embodiment of a spindle motor according to the invention having a base 210 in which a bearing bush 212 is accommodated. A stator arrangement 214 is provided in a conventional way at the outer region of the base 210, the stator arrangement enclosing the bearing bush 212 approximately annularly.

The bearing bush 212 has a central bore in which a shaft 216 is accommodated, the

surface of the bore in the bearing bush 212 and the outer surface of the shaft 216 being spaced apart from one another by a bearing gap 222. The bearing gap 222 is filled with a bearing fluid, preferably a bearing oil. The shaft 216 is supported vis-à-vis the bearing bush 212 by means of fluid dynamic radial bearings. The end of the shaft 216 protruding beyond the bearing bush 212 is connected to a hub 218, the shaft 216 and hub 218 being integrally formed, for example, as a single piece as shown in FIG. 3. The hub 218 is approximately bell-shaped in design and extends beyond and partially encloses the bearing bush 212. The hub 218 or shaft 216 may have a central tapped bore 230.

An annular permanent magnet 220 is disposed at an outside circumference of the hub 218, the annular permanent magnet 220 being located opposite the stator arrangement 214 and, together with the stator arrangement 214, forming the electromagnetic drive system of the spindle motor.

A peripheral surface of the bearing bush 212 and a facing surface on the inside circumference of the hub 218 are preferably slanted, so that a tapered capillary gap 224 is produced between the hub 218 and the bearing bush 212 that is connected to the bearing gap 222 via an annular gap 244 running horizontally between the hub 218 and the bearing bush 212. The capillary gap 224 is at least partially filled and the annular gap 244 fully filled with bearing fluid. The capillary gap 224 is used on the one hand to seal the bearing gap 222 towards the outside and on the other hand it acts as a fluid reservoir together with the annular gap 244. The open end of the capillary gap 224 is inclined slightly inwards in the direction of the rotational axis. On rotation of the hub, the bearing fluid is thereby forced radially outwards due to centrifugal forces and thus pressed into the interior of the capillary gap 224 and held in the capillary gap 224. The lower open end of the bearing bush is covered by a cover plate 228 that tightly seals the bearing in this region.

To prevent the shaft 216 from falling out of the bearing bush 212, a stopper ring 226 is preferably provided at the lower, free end of the shaft. The stopper ring 226 is freely disposed in an annular groove in the bearing bush 212 and does not come into contact with the surfaces of the bearing bush 212 or of the cover plate 228 when the spindle motor is operating under normal conditions.

The rotating parts of the motor, i.e. the shaft 216 or the hub 218 respectively, are axially supported vis-à-vis the bearing bush 212 or the base 210 respectively by means of a magnetic bearing that is provided between the stationary part of the motor and the rotating part of the motor. The magnetic bearing comprises a first magnet 232 that is disposed in a recess in the hub 218 and that abuts the annular gap. The first magnet 232 lies axially opposite a second magnet 234 that is disposed in a recess in the bearing bush 212 and likewise abuts the annular gap. The magnets 232 and 234 are polarized such that identical poles are located opposite each other so that the magnets 232, 234 repulse one another. The repulsive force of the magnets 232, 234 defines the width of the annular gap between the hub 218 and the bearing bush 212. The two magnets 232 and 234 are preferably annular in shape, or they are at least made up of a plurality of annularly disposed magnet segments, the diameter of the magnets 232, 234 being made as large as possible since the stability of the bearing increases in line with the diameter of the magnets.

In order to stabilize the bearing, the magnetic bearing preferably operates against a magnetic preload as described in conjunction with FIG. 1.

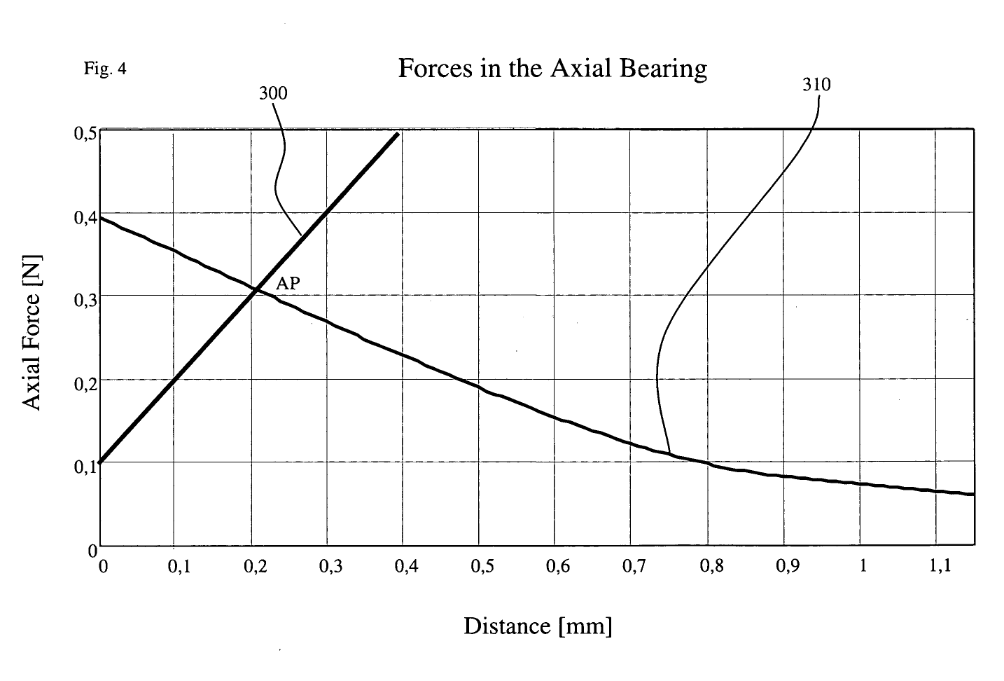

FIG. 4 shows an exemplary diagram of the forces acting in the axial bearing. The x-axis shows the distance in millimeters between the two magnets, magnets 32, 34 in FIG. 1 for example. The y-axis describes the forces acting in an axial direction in Newton.

Curve 310 depicts typical values for the axial force between two magnets 32, 34 of a spindle motor according to FIG. 1. As the distance between the magnets 32, 34 increases, the axial force decreases almost linearly. By comparison, curve 300 shows the axial force that is created by the magnetic preload in that the rotor magnet 20 is offset by a distance d to the magnetic center of the stator arrangement 14. This force generated by the magnetic preload as depicted in curve 300 acts inversely to the force generated by the magnets 32, 34, thus producing a stable operating point AP at which the forces have the same strength. This operating point AP determines the distance between the magnets 32, 34, in the illustrated embodiment a distance of approximately 0.2 mm, and thus the width of the capillary gap 24 between the bearing bush 12 and the hub 18.

### IDENTIFICATION REFERENCE LIST

10 Base

12 Bearing bush

14 Stator arrangement

16 Shaft

18 Hub

20 Rotor magnet arrangement

22 Bearing gap

24 Tapered capillary gap

26 Stopper ring

28 Cover plate

30 Tapped bore (hub)

32 Magnet (hub)

34 Magnet (bearing bush)

36 Stop

38 Radial bearings

40 Radial bearings

42 Rotational axis

d Offset

110 Base

112 Bearing bush

114 Stator arrangement

116 Shaft

118 Hub

120 Rotor magnet arrangement

122 Bearing gap

124 Tapered capillary gap

126 Stopper ring

128 Cover plate

130 Tapped bore (hub)

132 Magnet (hub)

134 Magnet (bearing bush)

210 Base

212 Bearing bush

214 Stator arrangement

216 Shaft

218 Hub

220 Rotor magnet arrangement

222 Bearing gap

224 Tapered capillary gap

226 Stopper ring

228 Cover plate

230 Tapped bore (hub)

232 Magnet (hub)

234 Magnet (bearing bush)

244 Annular gap

300 Axial force curve of the magn. preload

310 Axial force curve of the magnets

AP Operating point

1. A spindle motor having a stationary part and a rotating part that are rotatably supported with respect to each other by means of radial and axial bearing systems, the radial bearing system being a fluid bearing and the rotating part being driven by an electromagnetic drive system, characterized in that the axial bearing system is designed as a magnetic bearing and that it operates against a magnetic preload.

2. A spindle motor according to claim 1, characterized in that the stationary part comprises a base (10; 110; 210), a bearing bush (12; 112; 212) connected to the base and a stator arrangement (14; 114; 214).

3. A spindle motor according to claim 1, characterized in that the rotating part comprises a shaft (16; 116; 216) rotatably supported in the bearing bush (12; 112; 212), a hub (18; 118; 218) connected to the shaft and a magnet arrangement (20; 120; 220) connected to the hub.

4. A spindle motor according to claim 2, characterized in that the stator arrangement (14; 114; 214) and a magnet arrangement (20; 120; 220) are substantially disposed on one plane perpendicular to the rotational axis (42) of the spindle motor, the magnetic preload being created by an axial offset, d, of the stator arrangement (14; 114; 214) vis-à-vis the magnet arrangement (20; 120; 220).

5. A spindle motor according to claim 1, characterized in that the magnetic bearing consists of a first magnet (32; 132; 232) disposed on the rotating part which is located opposite a second magnet (34; 134; 234) disposed on the stationary part.

6. A spindle motor according to claim 5, characterized in that the magnets (32; 132; 232, 34; 134; 234) are polarized such that they repulse one another.

7. A spindle motor according to claim 5, characterized in that the first magnet (32; 132; 232) is disposed on a surface of the hub (18; 118; 218) that is located opposite the surface of the bearing bush (12; 112; 212) carrying the second magnet (34; 134; 234).

8. A spindle motor according to claim 5, characterized in that at least one of the magnets (32; 132; 232, 34; 134; 234) is annular in shape.

9. A spindle motor according to claim 5, characterized in that at least one of the magnets (32; 132; 232, 34; 134; 234) consists of a plurality of annularly disposed segments.

10. A spindle motor according to claim 5, characterized in that at least one of the magnets (32; 132; 232, 34; 134; 234) consists of a plurality of concentric rings of differing diameters that are disposed coaxially with respect to each other.

11. A spindle motor according to claim 10, characterized in that the rings are magnetized in the same direction or alternately in the opposite direction.

12. A spindle motor according to claim 10, characterized in that the rings are magnetized at different strengths.

13. A spindle motor according to claim 5, characterized in that one of the magnets (32; 132) has a greater width in a radial direction than the other magnet (34; 134).

14. A spindle motor according to claim 5, characterized in that the magnets (32; 132; 232, 34; 134; 234) are permanent magnets.

15. A spindle motor according to claim 5, characterized in that the magnets (32; 132; 232, 34; 134; 234) are plastic-bonded magnets.
